(19) United States
(12) Patent Application Publication
(10) Pub. No.: US 2011/0176777 A1
(43) Pub. Date: Jul. 21, 2011

(54) Apparatus For Optical Fiber Connection

(76) Inventor: Chien-Wen Chen, Hsinchu (TW)

(21) Appl. No.: 12/704,549

(22) Filed: Feb. 12, 2010

(30) Foreign Application Priority Data
Jan. 15, 2010 (TW) 099101113

(51) Int. Cl. G02B 6/38

(52) U.S. Cl. 385/66

(57) ABSTRACT

An apparatus for optical fiber connection is provided, including a shell base and at least an optical fiber coupling tube. The inner shape and the outer shape of the shell base are made according to the different types of optical fiber connection apparatus specifications. The optical fiber coupling tube is fixed to the inside of the shell base. The optical fiber tube includes a hard tube wall along the axis of the tube and at least a deformable tube wall. The deformable tube wall is resilient and can be slightly deformed and restored to original shape. When used for connecting optical fibers, the present invention provides precise positioning and the optical signal loss and pulling torque are all within specifications.

### FIELD OF THE INVENTION

The present invention generally relates to an apparatus for optical fiber connection, and more specifically to a special design inside the apparatus structure so as to enable the structure with appropriate firmness and capability to restore to original state to achieve the precision positioning, convenient operation and suitable fixation required for optical fiber connection.

### BACKGROUND OF THE INVENTION

FIG. 1 shows a dissected view of a conventional SC-type optical fiber connector. The optical fiber connector includes two shells 11, 12, two buckle units 13, 14 and a ceramic sleeve 15. The vertical side of buckle units 13 includes two facing buckle plates 131, and a hollow tube 132. The corresponding locations on buckle unit 14 also include two buckle plates 141 and a tube 142. Ceramic sleeve 15 includes a tiny trench 151 along the axis direction so that ceramic sleeve 15 has the capability of slight deformation and restoring to original shape. When assembled, ceramic sleeve 15 is placed inside tubes 132, 142, buckle units 13, 14 are aligned, buckled and fastened, and shells 11, 12 are sheathed and fixed to the outer side of buckle units 13, 14 to form an optical fiber connector. The characteristic of the structure is that: when the optical fiber ferrule is inserted from the two ends of ceramic sleeve 15, trench 151 enables ceramic sleeve to slightly deform the inner hole or enlarge the inner hole to allow the optical fiber ferrule to insert repeatedly. When ceramic sleeve 15 restores to original shape, the two optical fibers are positioned and aligned. However, this structure has the following disadvantages:

1. The number of parts is large so that the assembly process is complex and time-consuming;

2. The manufacturing cost is high because the ceramic sleeve must be considerable precision; and

3. More molds must be designed since the number of parts required is large; and then parts are manufactured and stored separately before assembled. This also leads to high manufacturing cost.

Therefore, it is imperative to provide an apparatus for optical fiber connection to overcome the aforementioned disadvantages.

### SUMMARY OF THE INVENTION

The primary object of the present invention is to provide an apparatus for optical fiber connection that is low in manufacturing cost and allows precision positioning. The internal structure of the apparatus uses a specially designed optical fiber coupling tube for alignment and coupling of the optical fiber ferrule. In addition, the optical fiber coupling tube can be manufactured by injection molding with a single material so as to greatly reduce the manufacturing cost. When the apparatus is in use, the apparatus can meet the international specification of optical signal loss and pulling torque after connecting optical fibers.

Another object of the present invention is to provide an apparatus for optical fiber connection for a wide range of applications, such as, SC-type optical fiber connector and LC-type optical fiber connector. In addition, the present invention is not limited to one-to-one optical fiber connection. The apparatus of the present invention is also applicable to many-to-many optical fiber connections.

Yet another object of the present invention is to provide an apparatus for optical fiber connection having a small number of parts and easy to manufacture. Comparing the SC-type optical fiber connection apparatus of the present invention with conventional SC-type optical fiber connector shows that the number of parts of the present invention can be reduced to three, two or even one, that is a great reduction when compared to the conventional connector having five parts. This also leads to save of manufacturing cost and assembly time. Furthermore, the product is more competitive in market as no expensive ceramic sleeve is required in the present invention.

To achieve the above objects, the apparatus for optical fiber connection of the present invention includes a shell base and at least an optical fiber coupling tube fixed inside the shell base. The inner shape and the outer shape of the shell base are made according to the different types of optical fiber connection apparatus. The optical fiber coupling tube is fixed to the inside of the shell base at the middle section so that the optical fiber tube is hanging and distributive inside the shell base. The optical fiber tube includes a hard tube wall along the axis of the tube and at least a deformable tube wall. The deformable tube wall is resilient and can be slightly deformed and restored to original shape. In addition, the structure of the optical fiber coupling tube can be divided into two types. The first type is an optical fiber coupling tube formed commonly with the hard tube wall and the deformable tube wall, and the second type is an optical fiber coupling tube formed commonly with near-round hard tube wall and deformable tube wall located inside the hard tube wall.

Furthermore, to facilitate the easy insertion of the optical fiber ferrule into the two ends of the optical fiber coupling tube, the present invention can also allow the optical fiber coupling tube to keep an offset of 2°. The application is as follows: the middle section of the optical fiber coupling tube is fixed by a fixed plate with at least a trench. The distribution of the trench is close to the engagement location of the fixed plate and the optical fiber coupling tube.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a dissected view of a conventional optical fiber connector;

FIG. 2 shows a top view of a first embodiment of the present invention;

FIG. 3 shows a partial cross-section view of the first embodiment of the present invention;

FIG. 4 shows a partial cross-section view of the second embodiment of the present invention;

FIG. 5 shows a partial cross-section view of the third embodiment of the present invention;

FIG. 6 shows a partial cross-section view of the fourth embodiment of the present invention;

FIG. 7A shows a partial cross-section view of the fifth embodiment of the present invention;

FIG. 7B shows a side view of the fifth embodiment of the present invention;

FIG. 8 shows a dissected view of the first embodiment of the present invention;

FIG. 9 shows a dissected view of another embodiment of the present invention;

FIG. 10 shows a top view of a 2-to-2 optical fiber connection apparatus of the present invention;

FIG. 11 shows a partial cross-sectional schematic view of an LC-type optical fiber connection apparatus according to the present invention; and

FIG. 12 shows a top view of an LC-type optical fiber connection apparatus according to the present invention.

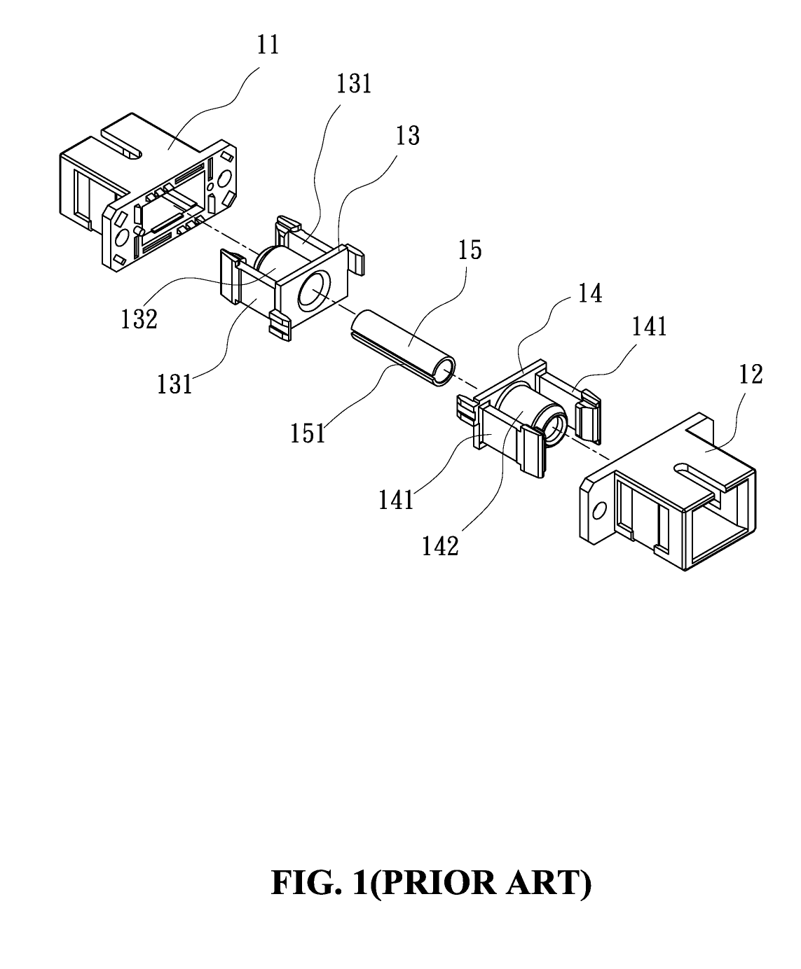

### DETAILED DESCRIPTION OF THE PREFERRED EMBODIMENTS

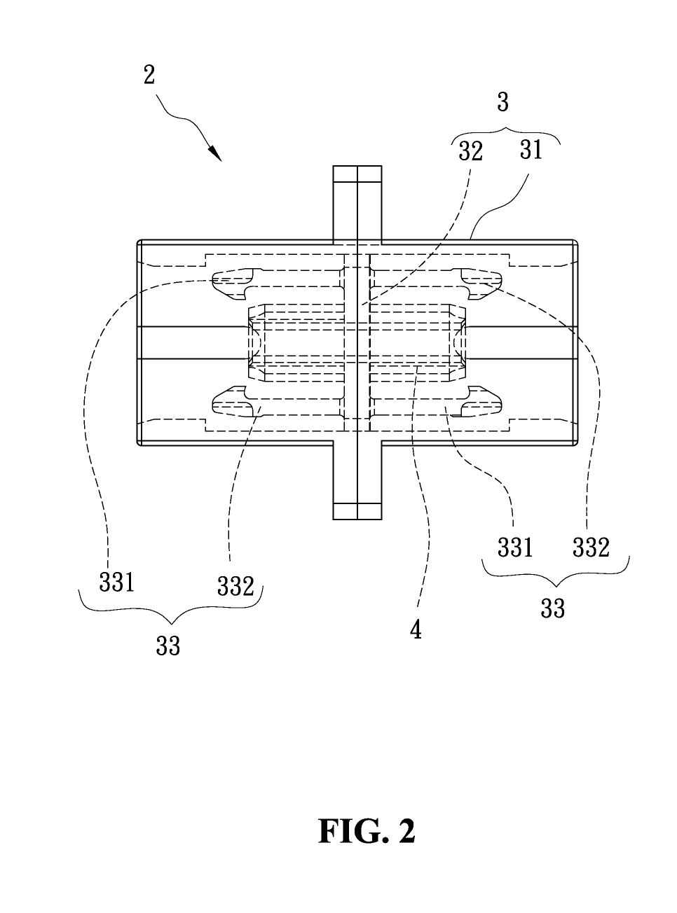

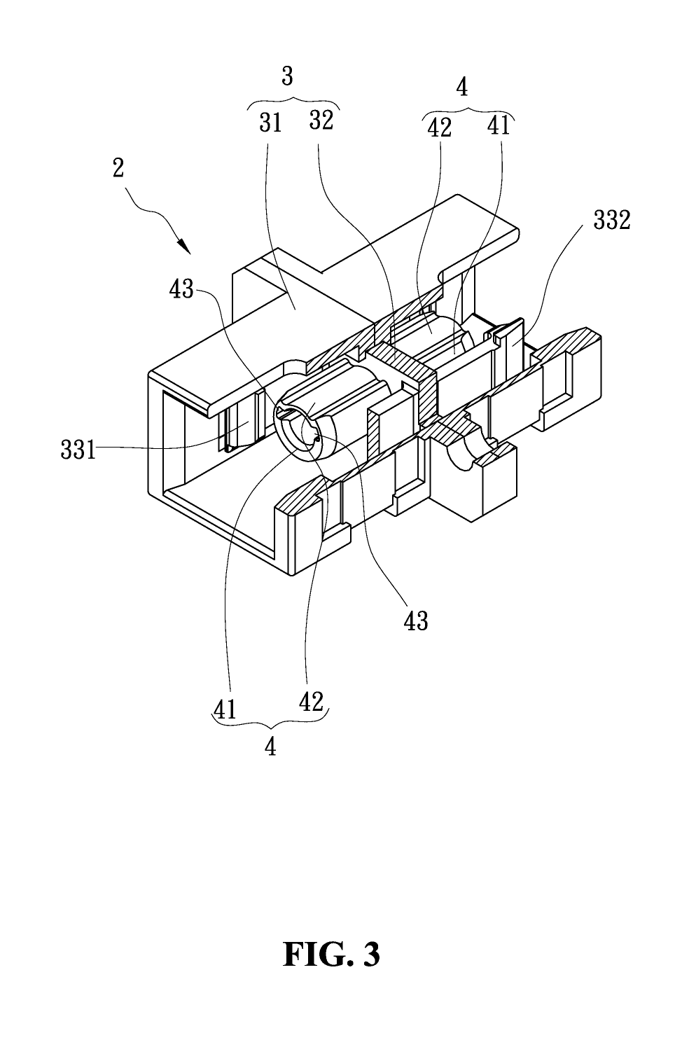

FIG. 2 and FIG. 3 show respectively a top view and a cross-sectional view of the present invention applied to a one-to-one optical fiber connection apparatus according to the present invention. An optical fiber connection apparatus 2 of the present invention includes a shell base 3 and at least an optical fiber coupling tube 4. The inner shape and the outer shape of shell base 3 are made to meet requirements of different types of optical fiber connection apparatus. The present embodiment is an SC-type optical fiber connection apparatus; hence, the structure of shell base 3 includes a shell 31, a fixed plate 32 and two buckle sets 33. Fixed plate 32 is located inside shell 31 at the middle section, and is fixed to the outer wall of the middle section of optical fiber coupling tube 4. Two buckle sets 33 are located respectively on the two profile sides of the back of fixed plate 32. Buckle set 33 includes two facing buckle plates 331, 332. Buckle plates 331, 332 are resilient, and have the shape and structure made to match the optical fiber ferrule. Shell base 3 is similar to the conventional structure, and the detailed description is omitted here. The key feature of the present invention is optical fiber coupling tube 4. The outer wall of optical fiber coupling tube 4 is engaged to fixed plate 32 at the middle section so that optical fiber coupling tube 4 is distributed on both sides of fixed plate 32 in a hanging arm manner. Optical fiber coupling tube 4 includes a hard tube wall 41 along the axis of the coupling tube and at least a deformable tube wall 42. The inside of optical fiber coupling tube 4 is a hollow tube for optical fiber ferrule coupling. Deformable tube wall 42 is resilient and can be slightly deformed and restored to original shape. Optical fiber coupling tube 4 is made of polymer material, such as, synthesized plastic, synthesized rubber, synthesized fiber, synthesized resin, and so on.

The theory behind the present invention is that the optical fiber ferrule is inserted into optical fiber coupling tube 4, deformable tube wall 42 slightly deforms the inner hole to accommodate the continuous insertion of optical fiber ferrule. Then, the resilience of deformable tube wall 42 will restore to original shape to achieve the fastening holding of coupled optical fiber ferrules. In addition, the restoring capability of deformable tube wall 42 can also push the optical fiber ferrule towards the inner wall of hard tube wall 41. AT this point, the baseline surface of the optical fiber ferrule coupling is the inner wall of hard tube wall 41. In this manner, the two optical fiber ferrules inserted from two ends of optical fiber coupling tube 4 will be aligned on the same center axis to assure the correct positioning and coupling of the optical fibers.

The above description shows the importance of deformable tube wall 42 of optical fiber coupling tube 4. But how does deformable wall tube 42 achieve the capability of slight deformation and restoration to original shape? The following provides a plurality of embodiments. As shown in FIG. 3, optical fiber coupling tube 4 includes a hard tube wall 41 and deformable tube wall 42. The thickness of deformable tube wall 42 is less than the thickness of hard tube wall 41, and a concave trench 43 is located on the tube wall of hard tube wall 41 close to deformable tube wall. Concave trench 43 can be formed on at least one of the locations of inner wall or outer wall of hard tube wall 41, and is distributed along the axial direction of hard tube wall 41. The present embodiment includes two concave trenches on the inner wall of hard tube wall 41. Because hard tube wall 41 is thicker, made of hard material and not deformable, the use of thinner deformable tube wall 42 and concave trench 43 will enable deformable tube wall 42 with the capability to slightly deform and restore to original shape. In addition, the size of inner hole formed by hard tube wall 41 and deformable tube wall 42 is less than or equal to the size of the optical fiber ferrule to be connected.

In the above embodiment, optical fiber coupling tube 4 also includes two important features, thinner deformable tube wall 42 and axial direction concave trenches 43. But the present invention is not limited to the above embodiment. For example, the optical fiber coupling tube can also include a thinner deformable tube wall without concave trenches. Alternatively, the optical fiber coupling tube can have hard tube wall and deformable tube wall of equal thickness, but having at least a concave trench at the locations as the above embodiment. In this manner, the concave trench allows the location of the deformable tube wall to change.

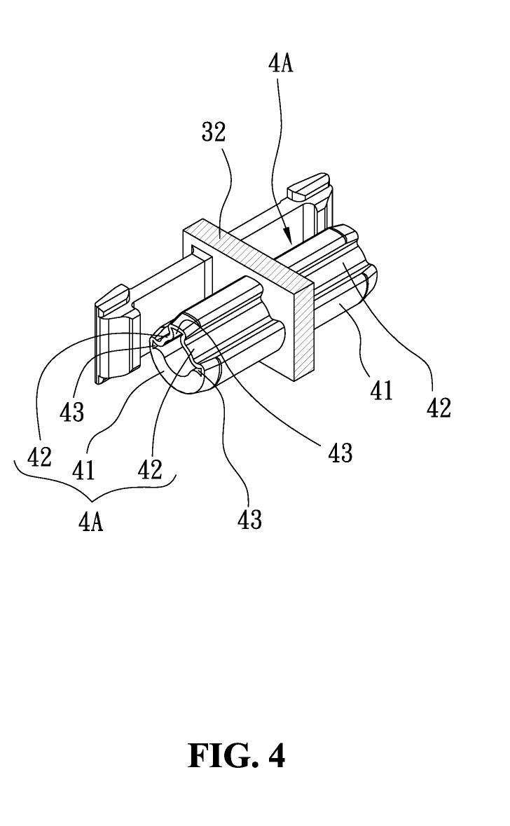

Because the main feature of the present invention is the optical fiber coupling tube, the following embodiments only show fixed plate 32 and optical fiber coupling tube. FIG. 4 shows a second embodiment of the present invention. As shown in FIG. 4, optical fiber coupling tube 4A includes hard tube wall 41 and two deformable tube walls 42, all distributed along the axial direction so as to form a round inner hole inside the tube. Deformable tube wall 42 must be thinner than hard tube wall 41. The present embodiment includes three concave trenches 43, where two are formed at the location on hard tube wall 41 close to deformable tube wall 42, and one is formed between two deformable tube walls 42. To maintain the strength of hard tube wall 41, the part of the circumference of optical fiber coupling tube 4A formed by hard tube wall 41 is preferably at least more than half of the total circumference.

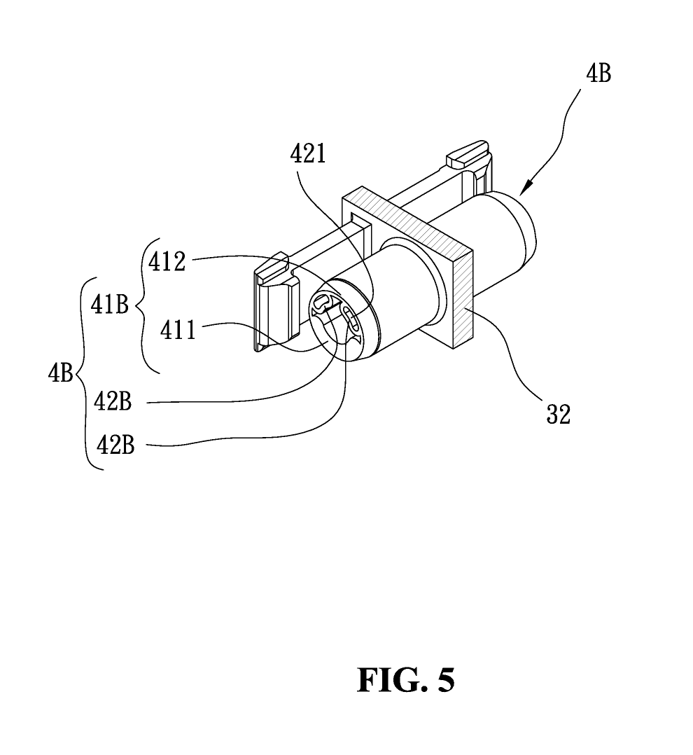

FIG. 5 shows a third embodiment of the present invention. As shown in FIG. 5, optical fiber coupling tube 4B includes a hard tube wall 41B and at least a deformable tube wall 42B. Deformable tube wall 42B is located inside hard tube wall 41B. In the present embodiment, the shape of the inner hole inside optical fiber coupling tube 4B is formed by hard tube wall 41B and deformable tube wall 42B. Hard tube wall 41B is a round tube wall formed with a thick wall region 411 and thin wall region 412, where deformable tube wall 42B is located at the inner wall of thin wall region 412. A gap exists between thin wall region 412 and some parts of deformable tube wall 42B so that deformable tube wall is able to slightly deform and restore to original shape. The present embodiment includes two deformable tube walls 42B. In addition, the size of the inner hole formed by thick wall region 411 of hard tube wall 41B and two deformable tube walls 42B must be less than or equal to the size of the optical fiber ferrule to connect.

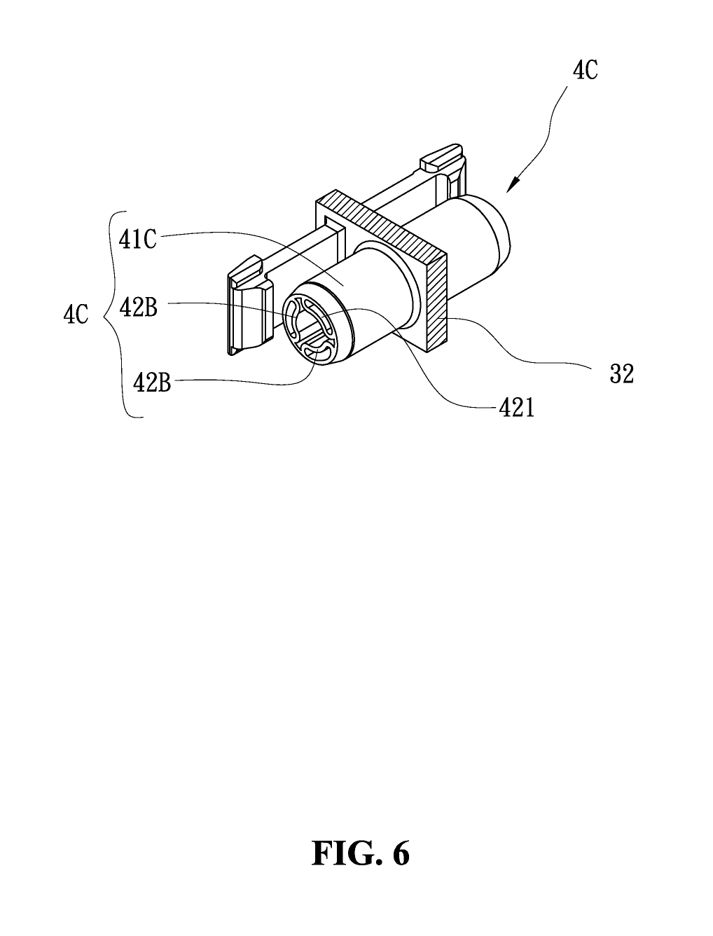

FIG. 6 shows a fourth embodiment of the present invention. As shown in FIG. 6, optical fiber coupling tube 4C is formed by a hard tube wall 41C and three deformable tube walls 42B, with all deformable tube walls 42B distributed inside hard tube wall 41C along the axial direction. In the present embodiment, the inner hole inside optical fiber coupling tube 4C is formed by three deformable tube walls 42B. Hard tube wall 41C of the present embodiment is a thin tube with strength and not deformable. Deformable tube walls 42B are engaged to the inside of hard tube wall 41C with gap between inner wall of hard tube wall 41C and some part of deformable tube walls 42B to allow slight deformation and restoration to original shape. A special condition of the present embodiment is that the restoration force of three deformable tube walls 42B must pass the center of the tube because the inner hole is formed by the three deformable tube walls so that the optical fiber ferrules inserted at two ends of optical fiber coupling tube can be aligned on the same center line.

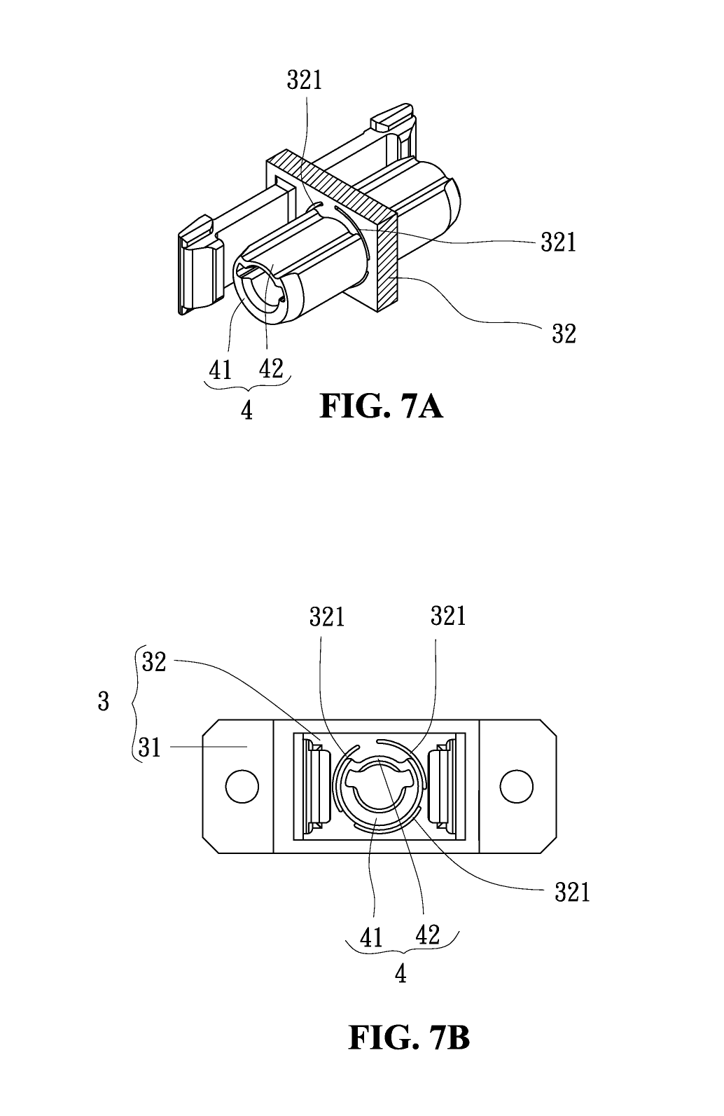

FIG. 7A and FIG. 7B show a fifth embodiment of the present invention. The object of the present embodiment is to allow the two ends of optical fiber coupling tube 4 for 2° offset to the right and left along the center line as the baseline. In the present embodiment, the outer wall of optical fiber coupling tube 4 is still engaged to fixed plate 32. Fixed plate 32 includes a plurality of trenches 321 penetrating fixed plate 32 and in an arc shape. The distribution of trenches 321 is located close to the joint of fixed plate 3 and optical fiber coupling tube 4. The present embodiment includes three trenches 321 uniformly distributed on fixed plate 32 in a broken ring shape. In this manner, the area of direct engagement between fixed plate 32 and optical fiber coupling tube 4 decreases so that entire optical fiber coupling tube 4 allows an offset of 2°. Also, the design of trenches 321 is applicable to the embodiments of FIGS. 4-6.

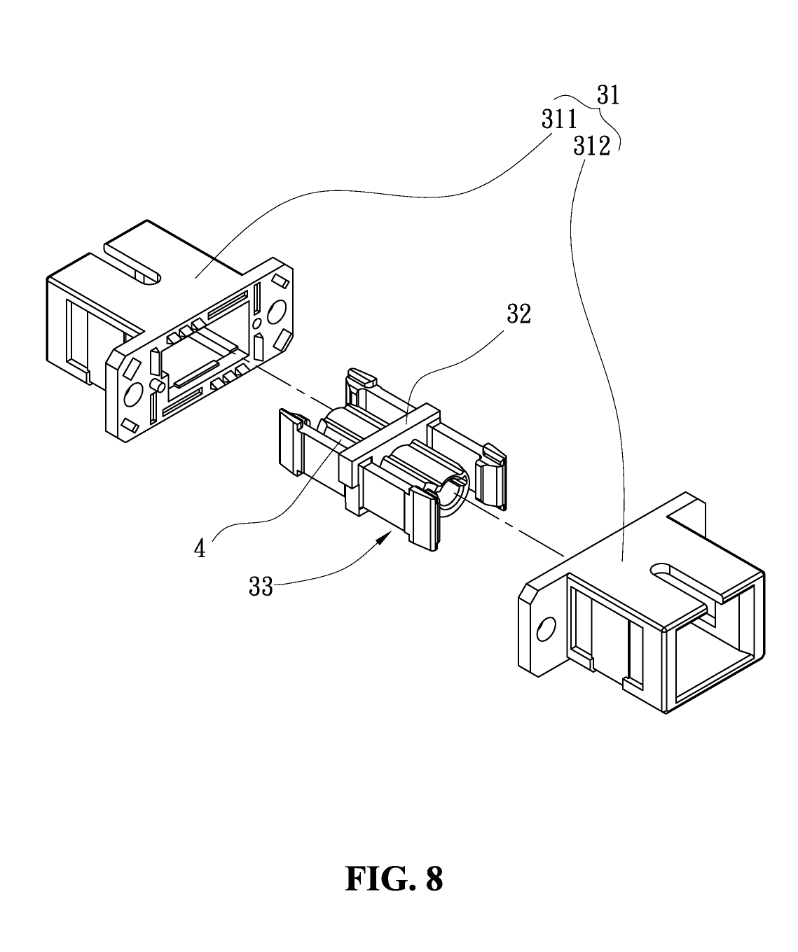

FIG. 8 shows a dissected view of the present invention. To facilitate the ease of manufacturing, the present invention can be assembled by three parts that can be manufactured separately, where the first part includes fixed plate 32, two buckle sets 33 and optical fiber coupling tube 4, and shell 31 includes a first shell part 311 and second shell part 312. The above three parts are all manufactured with injection molding. In assembly, the first part is placed in the middle. Then, the second and third parts are aligned to engage. The parts can be further glued together with glue or high frequency gluing technology.

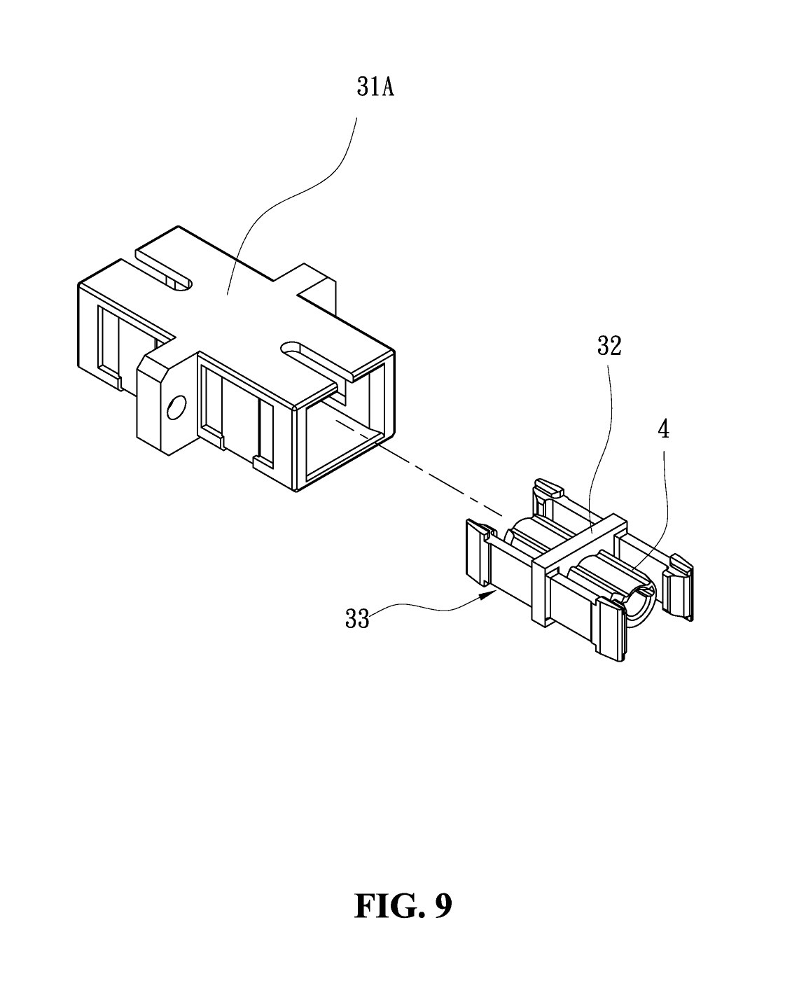

FIG. 9 shows a dissected view of another embodiment of the present invention. In this embodiment, the first part includes fixed plate 32, two buckle sets 33 and optical fiber coupling tube 4, and the second part is shell 31A. Shell 31A is a hollow shell. The above two parts can both be manufactured with injection molding. This embodiment shows that the present invention can use to parts to realize an apparatus for optical fiber connection. As shown in FIG. 8 and FIG. 9, the apparatus for optical fiber connection of the present invention can include either two or three parts, depending on the design. Furthermore, the designer can integrate the fixed plate and optical fiber coupling tube as the first part and the buckle sets as the second part, or even change the shape of the shell so that the entire apparatus for optical fiber connection can be made as a single part to be manufactured with injection molding. Hence, the present invention is not limited to any specific number of parts to form the optical fiber connection apparatus.

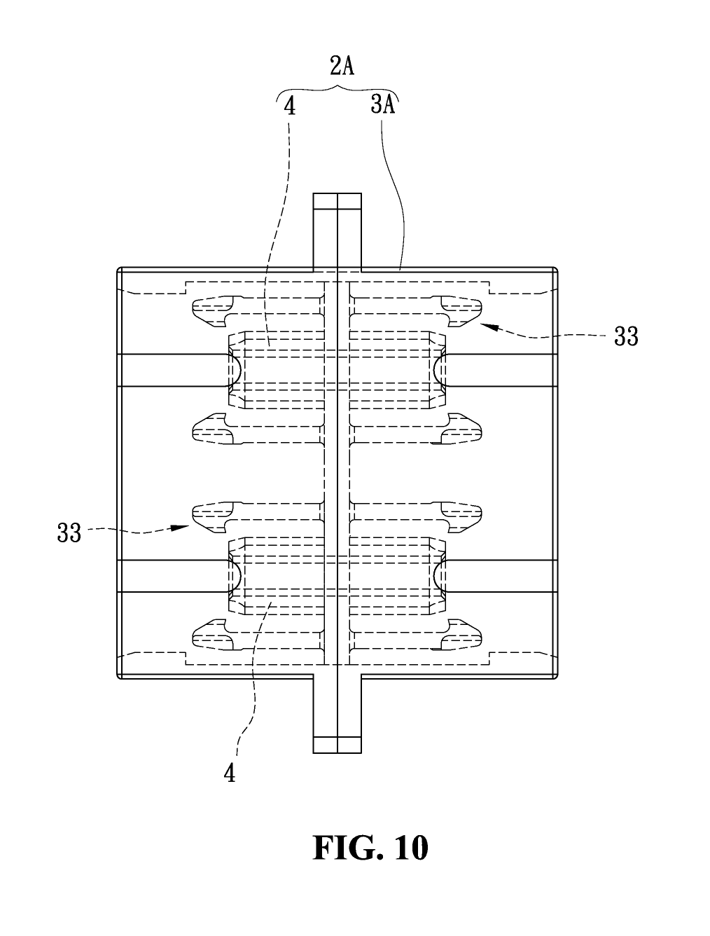

FIG. 10 shows a schematic view of a 2-to-2 SC-type optical fiber connection apparatus according to the present invention. In the present embodiment, optical fiber connection apparatus 2A is of 2-to-2 specification, and the shape of shell base 3A is different, for example, shell base 3A includes four buckle sets 33. Additionally, the embodiment includes two optical fiber coupling tubes. As aforementioned, the present invention is applicable to both one-to-one and many-to-many applications.

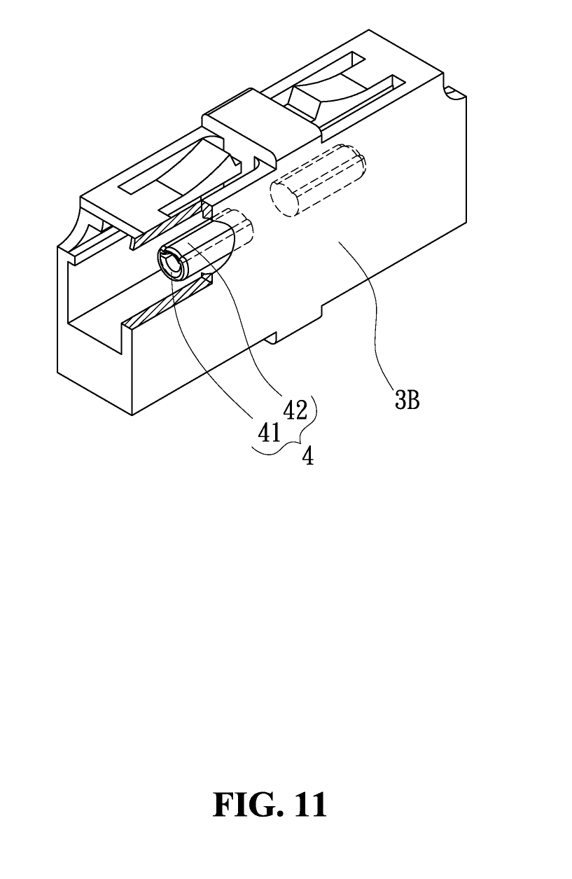

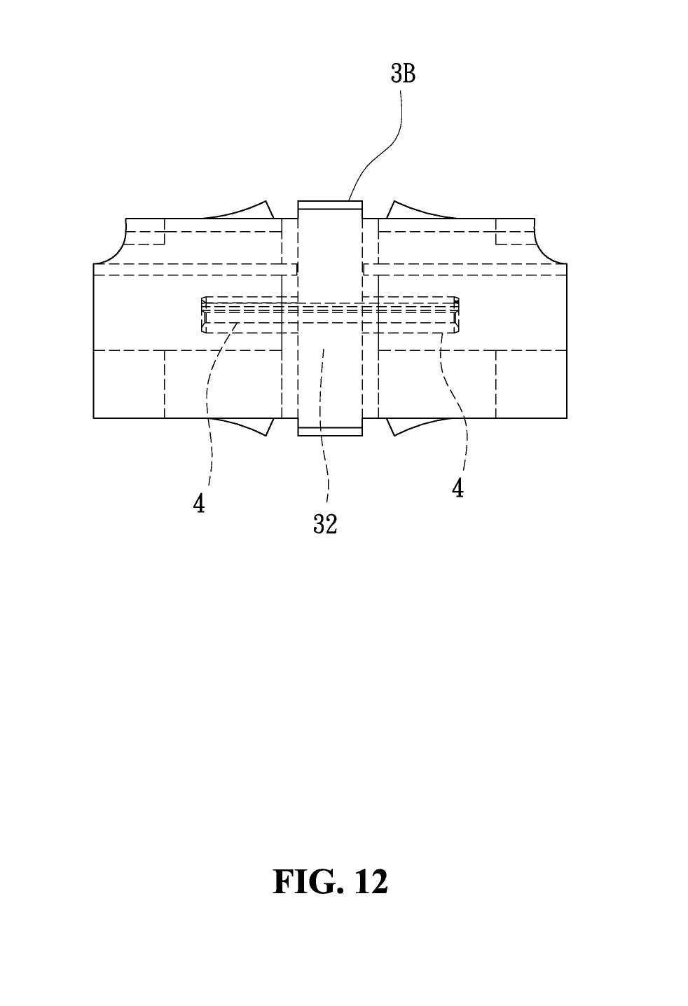

FIG. 11 and FIG. 12 show a partial cross-sectional view and a tope view of a one-to-one LC-type optical fiber connection apparatus according to the present invention. Shell base 3B of the present embodiment is of LC-type specification, and therefore, does not include buckle sets. Optical fiber coupling tube 4 is still fixed to the inside of shell base 3B at the middle section with a fixed plate 32. Similarly, the present invention is also applicable to a 2-to-2 LC-type optical fiber connection apparatus.

The aforementioned embodiments show that the present invention is applicable to various types of optical fiber connection apparatuses, such as, SC-type and LC-type, one-to-one and many-to-many, and so on. The shape of the shell base can be designed to match the respective specification. The important commonality is that each optical fiber connection apparatus must include at least an optical fiber coupling tube of the present invention.

In summary, the optical fiber connection apparatus of the present invention includes an optical fiber coupling tube. The inside of optical fiber coupling tube is a hollow tube for optical fiber coupling. The optical fiber coupling tube is fixed to the inside of shell base with a fixed plate at the middle section on the outside. The optical fiber coupling tube is formed by hard tube wall and deformable tube wall, distributed along the axial direction. The deformable tube wall allows the inner hole inside the tube to deform to facilitate easy insertion of rigid optical fiber ferrule. The capability to restore to original shape of the deformable tube wall provides strong holding onto the inserted optical fiber ferrule. The hard tube wall provides a baseline for the optical fiber ferrule to be pushed towards to the baseline by the restoration force of the deformable tube wall so that the two optical fiber cables to connect can be aligned to the same center line. The present invention is easy to operate, and provides strong holding and precise positioning.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An apparatus for optical fiber connection, comprising:
a shell base and least an optical fiber coupling tube; said shell base having a shape matching specification of said optical fiber connection apparatus, said optical fiber coupling tube being fixed to inside to said shell base, inside of said optical fiber coupling tube being hollow tube for optical fiber ferrules to couple, with main feature of: said optical fiber coupling tube being formed by a hard tube wall and at least a deformable tube wall, both distributed along axial direction, said deformable tube wall have a capability of slight deformation and restoration to original shape.

2. The apparatus as claimed in claim 1, wherein thickness of said deformable tube wall is less than thickness of said hard tube wall so that said deformable tube wall has resilience to provide said capability of slight deformation and restoration to original shape.

3. The apparatus as claimed in claim 1, wherein concave trenches are formed on at least one of the locations of inner wall or outer wall of said deformable tube wall close to connection to said hard tube wall so that said deformable tube wall has resilience to provide said capability of slight deformation and restoration to original shape.

4. The apparatus as claimed in claim 1, wherein thickness of said deformable tube wall is less than thickness of said hard tube wall, and at least a concave trench is formed on at least one of the locations of inner wall or outer wall of said hard tube wall close to connection to said hard tube wall so that said deformable tube wall has resilience to provide said capability of slight deformation and restoration to original shape.

5. The apparatus as claimed in claim 1, wherein shape and size of inner hole of said optical fiber coupling tube is formed by said deformable tube wall and said hard tube wall.

6. The apparatus as claimed in claim 1, wherein at least a said deformable tube wall is located inside said hard tube wall, gap exists between said some part of said hard tube wall and some part of said deformable tube wall so that said deformable tube wall has resilience to provide said capability of slight deformation and restoration to original shape.

7. The apparatus as claimed in claim 6, wherein a plurality of said deformable tube walls are located inside said hard tube wall, and shape and size of inner hole of said optical fiber coupling tube is formed by said deformable tube wall and said hard tube wall.

8. The apparatus as claimed in claim 6, wherein said shape of inner hole of said optical fiber coupling tube is formed by said deformable tube wall and said hard tube wall.

9. The apparatus as claimed in claim 1, wherein inside of said shell base has a fixed plate engaged to outer wall of said optical fiber coupling tube so that said optical fiber coupling tube distributed on both sides of said fixed plate in hanging arm manner.

10. The apparatus as claimed in claim 9, wherein said fixed plate has at least a trench, and said trench distributed on said fixed plate close to said optical fiber coupling tube.

11. The apparatus as claimed in claim 10, wherein said trench penetrates entire said fixed plate in an arc shape, and said trench is distributed on said fixed plate in a broken ring shape.

12. The apparatus as claimed in claim 1, wherein said apparatus for optical fiber connection is of one-to-one specification.

13. The apparatus as claimed in claim 1, wherein said apparatus for optical fiber connection is of many-to-many specification.

14. The apparatus as claimed in claim 1, wherein said apparatus for optical fiber connection is of SC-type optical fiber connection specification.

15. The apparatus as claimed in claim 1, wherein said apparatus for optical fiber connection is of LC-type optical fiber connection specification.

16. An apparatus for optical fiber connection, comprising:
a shell base and least an optical fiber coupling tube; said shell base having a shape matching specification of said optical fiber connection apparatus, said optical fiber coupling tube being fixed to inside to said shell base, inside of said optical fiber coupling tube being hollow tube for optical fiber ferrules to couple, with main feature of: said optical fiber coupling tube being formed by a hard tube wall and at least a deformable tube wall, both distributed along axial direction, said deformable tube wall being located inside said hard tube wall, and gap existing between some part of said deformable tube wall and some part of inner wall of said hard tube wall, said deformable tube wall have a capability of slight deformation and restoration to original shape.

17. The apparatus as claimed in claim 16, wherein a plurality of said deformable tube walls are located inside said hard tube wall, and shape and size of inner hole of said optical fiber coupling tube is formed by said deformable tube wall and said hard tube wall.

18. The apparatus as claimed in claim 16, wherein said shape of inner hole of said optical fiber coupling tube is formed by said deformable tube wall and said hard tube wall.

19. An apparatus for optical fiber connection, comprising:
a shell base and least an optical fiber coupling tube; said shell base having a shape matching specification of said optical fiber connection apparatus, inside of said shell base having a fixed plate engaged to outer wall of said optical fiber coupling tube so that said optical fiber coupling tube being distributed on both sides of said fixed plate in a hanging arm manner, said fixed plate having at least a trench, said trench being distributed on said fixed plate close to said optical fiber coupling tube; said optical fiber coupling tube being formed by a hard tube wall and at least a deformable tube wall, both distributed along axial direction, inside of said optical fiber coupling tube being hollow tube for optical fiber ferrules to couple, said deformable tube wall have a capability of slight deformation and restoration to original shape.
